(19) United States
(12) Patent Application Publication
(10) Pub. No.: US 2005/0236571 A1
(43) Pub. Date: Oct. 27, 2005

(54) Environmental measuring apparatus

(75) Inventor: Hideki Suzumura, Iwakura-shi (JP)

Correspondence Address: CONLEY ROSE, P.C., P. O. BOX 3267, HOUSTON, TX, 77253-3267, US

(73) Assignee: Takachiho Sangyo Co., LTD., Nagoya-shi (JP)

(21) Appl. No.: 11/062,230

(22) Filed: Feb. 18, 2005

(30) Foreign Application Priority Data
Apr. 21, 2004 (JP) 2004-125581

(51) Int. Cl. G05B 23/02; G01J 5/20

(52) U.S. Cl. 250/338.1; 709/224; 340/3.1

(57) ABSTRACT

An environmental measuring apparatus for measuring a plurality of environmental conditions within a server rack or a server room may include a plurality of sensing devices for detecting the plurality of environmental conditions, and a measuring device electrically connected to the sensing devices and having a plurality of predetermined voltage-physical value converting tables previously stored therein. Each of the sensing devices is arranged and constructed to generate at least one analog sensing voltage representative of a detecting value corresponding to the environmental condition and at least one sensing device identification signal corresponding to the sensing device. The measuring device is arranged and constructed to select a corresponding voltage-physical value converting table from the voltage-physical value converting tables based on the at least one sensing device identification signal and to convert the at least one analog sensing voltage to a physical value with reference to the selected voltage-physical value converting table.

### BACKGROUND OF THE INVENTION

1. Field of the Invention

The present invention relates to environmental measuring apparatus for monitoring or measuring environmental conditions, e.g., temperatures within a server rack that receives servers, temperatures within a server room, conditions of a power supply, or other such conditions.

2. Description of the Related Art

An environmental measuring apparatus for monitoring such environmental conditions is taught, for example, by Japanese Laid-Open Patent Publications Numbers 2000-010633 and 2002-135218.

Japanese Laid-open Patent Publications Numbers 2000-010633 teaches a server box that is designed by taking into consideration downsizing, power saving, low heat generation, enhanced security, seismic safety, or other such factors. The server box has an environmental monitoring apparatus (i.e., an environmental measuring apparatus) for monitoring various environmental conditions within the server box. The environmental monitoring apparatus included a measuring device and a plurality of sensors (e.g., temperature sensors, humidity sensors and fan sensors) that are connected to the measuring device via interfaces and terminals.

In this known art, the interfaces and the terminals are respectively exclusive to the respective sensors. Therefore, the specific sensors can only be connected to the terminals for such specific sensors. For example, the temperature sensors can only be connected to the terminals for the temperature sensors. That is, the temperature sensors cannot be connected to the terminals for the humidity sensors.

Japanese Laid-open Patent Publications Numbers 2002-135218 teaches an environmental monitoring apparatus (i.e., an environment measuring apparatus) for monitoring various environmental conditions (e.g., temperatures and humidity) within a cabinet rack that stores various telecommunication devices. The environmental monitoring apparatus includes a plurality of sensors and a measuring device. The sensors are connected to the measuring device via connector slots formed in the measuring device. The measuring device includes a plurality of monitoring circuit boards corresponding to the sensors. The circuit boards are removably incorporated to the measuring device via board slots formed in the measuring device.

In this known art, the desired circuit boards can be optionally inserted into the board slots. Therefore, the monitoring functions of the monitoring apparatus can be changed by replacing the circuit boards with other circuit boards. Also, it is possible to provide additional monitoring functions to the monitoring apparatus by adding new circuit boards to the measuring device. However, the connector slots for the sensors are typically exclusive to the respective sensors. Therefore, it is necessary to previously form various types of many connector slots in the measuring device.

### SUMMARY OF THE INVENTION

It is one object of the present teachings to provide improved environmental measuring apparatus for measuring or monitoring environmental conditions.

For example, in one aspect of the present teachings, an environmental measuring apparatus for measuring a plurality of environmental conditions within a server rack or a server room may include a plurality of sensing devices for detecting the plurality of environmental conditions, and a measuring device electrically connected to the sensing devices and having a plurality of predetermined voltage-physical value converting tables previously stored therein. Each of the sensing devices is arranged and constructed to generate at least one analog sensing voltage representative of a detecting value corresponding to the environmental condition and at least one sensing device identification signal corresponding to the sensing device. The measuring device is arranged and constructed to identify each of the sensing devices based on the at least one sensing device identification signal, thereby selecting a corresponding voltage-physical value converting table from among the selected voltage-physical value converting tables and converting the at least one analog sensing voltage to a physical value with reference to the selected voltage-physical value converting table.

According to this environmental measuring apparatus, all of the sensing devices can generate detecting values (e.g., a temperature and a revolution speed) corresponding to the environmental conditions as analog sensing voltages and transmit the generated analog sensing voltages to the measuring device. Therefore, it is not necessary to form special-purpose connector sockets in the measuring device in order to connect the respective sensing devices to the measuring device. That is, the measuring device can be designed to have general-purpose connector sockets that can receive every type of sensing device. Consequently, it is possible to easily change the types of the sensing devices, if necessary.

Other objects, features and advantages of the present invention will be readily understood after reading the following detailed description together with the accompanying drawings and the claims.

### BRIEF DESCRIPTION OF THE DRAWINGS

FIG. 1(A) is a perspective view of a measuring device of an environmental measuring apparatus according to one representative embodiment of the present teachings; and

FIG. 1(B) is a side view of one (a temperature sensor) of various sensing devices connected to the environmental measuring apparatus; and

FIG. 2 is an explanatory view illustrating a process in which temperatures detected by the temperature sensor are converted into temperature values by means of the measuring device; and

FIG. 3 is a block diagram of the measuring device; and

FIG. 4 is a table illustrating an example of sensing device identification data that are assigned for the various sensing devices; and

FIG. 5 is a view illustrating an example of an environmental measuring system having a plurality of environmental measuring apparatus.

### DETAILED DESCRIPTION OF THE INVENTION

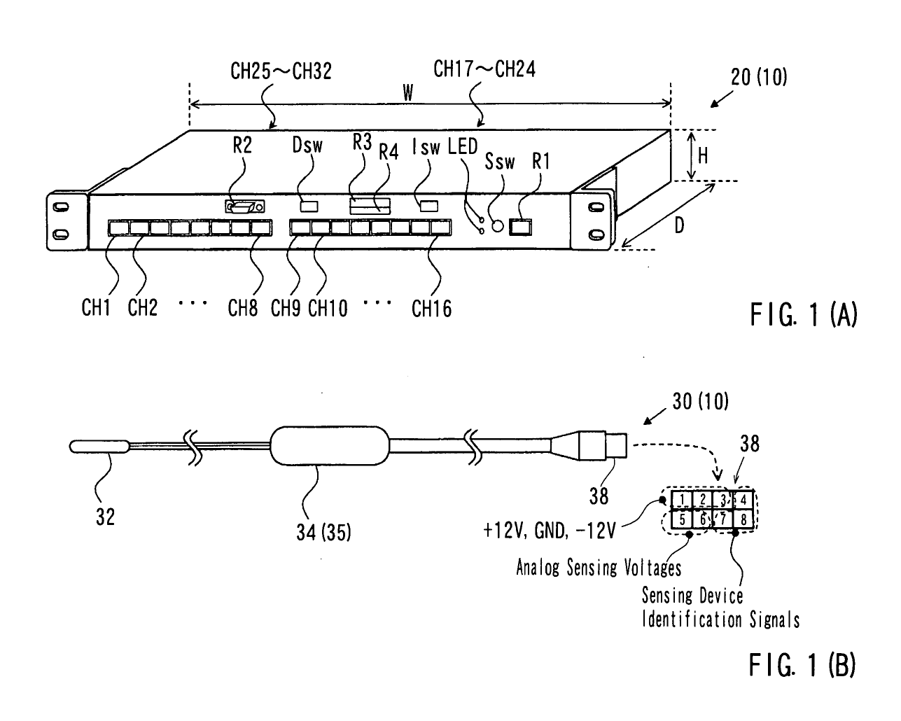

A representative embodiment of the present teachings will now be described in further detail with reference to FIGS. 1(A) to 5.

As shown in FIG. 1(A) and 1(B), a representative environmental monitoring or measuring apparatus 10 includes a measuring device 20 and a plurality of sensing devices 30 (one of which is shown) that are electrically connected to the measuring device 20. The environmental measuring apparatus 10 is arranged and constructed to measure environmental conditions within a server rack (not shown). The measuring device 20 may have a width W, a height H and a depth D. These dimensions W, H and D may preferably be determined such that the measuring device 20 can be received within the server rack.

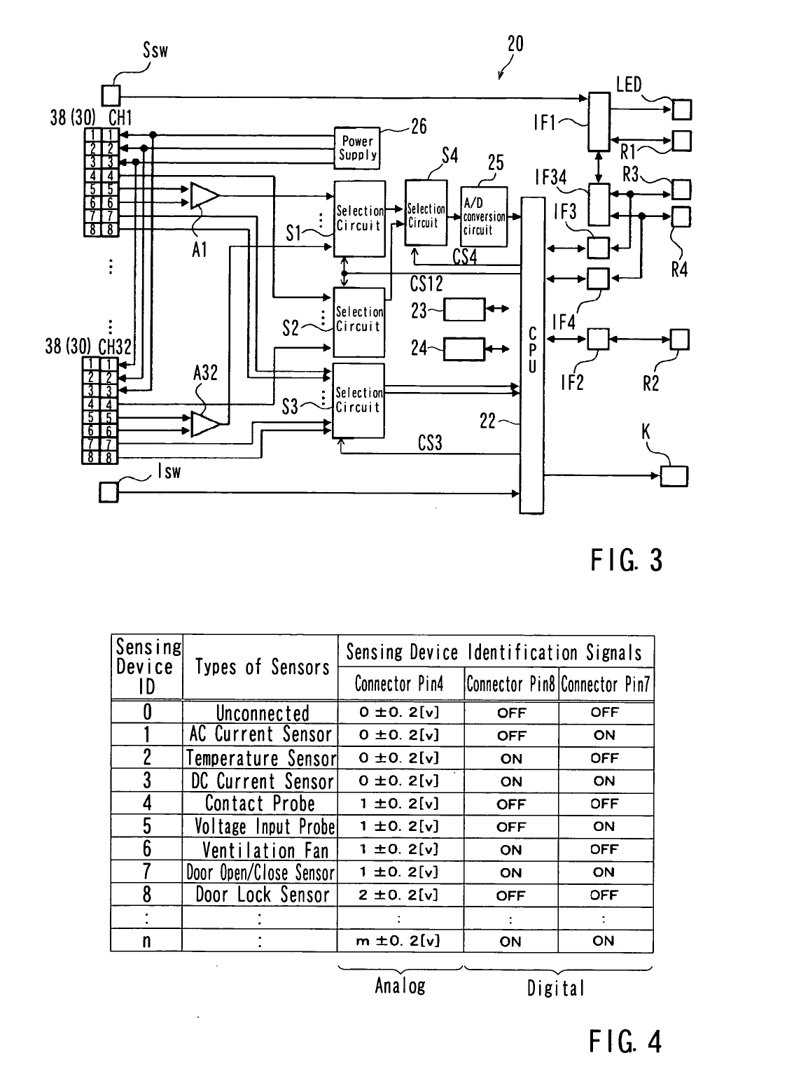

As shown in FIG. 1(A), the measuring device 20 has a plurality of connector sockets CH1-CH8 and CH9-CH16 that are formed in a front surface thereof. Also, the measuring device 20 has a plurality of connector sockets CH17-CH24 and CH25-CH32 that are formed in a rear surface thereof. All of these thirty two (32) connector sockets CH1-CH32 may preferably have the same shape (e.g., a LAN (local area network) connector socket shape) as each other. Further, the connector sockets CH1-CH32 may respectively have a plurality of contacts or connector slots 1-8 (FIG. 3).

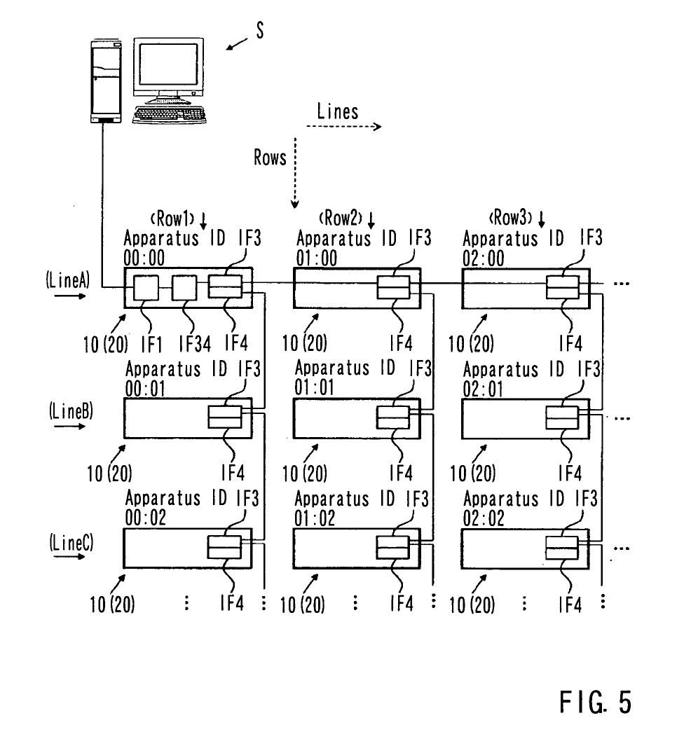

As shown in FIG. 1(A), the measuring device 20 may preferably have a connector R1 that can connect to a management unit S (FIG. 5) such as a personal computer. In addition, the measuring device 20 may preferably have a connector R2 that can connect to a reloading device (not shown) when it is necessary to reload or rewrite programs or data stored within the measuring device 20. Also, the measuring device 20 may preferably have connectors R3 and R4 that are utilized to connect the measuring device 20 to other measuring devices (FIG. 5).

As shown in FIG. 1(B), each of the sensing devices 30 has a sensing portion or sensing element 32, a converting portion or converter 34, and a connecting portion or connector plug 38 for connecting the sensing device 30 to the measuring device 20. The sensing element 32 detects a specific environmental condition (e.g., temperatures within the server rack) and transmits detecting values (i.e., physical values) corresponding to the environmental condition to the converter 34. The converter 34 receives and converts the detecting values and generates analog sensing voltages (i.e., converted signals) representative of the detecting values. Further, the converter 34 includes an identification signal generator 35. The identification signal generator 35 functions to generate three identification signals identifying the type of the sensing device 30 (which will be hereinafter referred to as “sensing device identification signals”) and to transmit the sensing device identification signals to the measuring device 20 so that the measuring device 20 can identify the type of the sensing device 30 now in use. The identification signal generator 35 can be optionally controlled, if necessary. That is, the sensing device identification signals generated by the identification signal generator 35 can be optionally changed so as to correspond to the type of the sensing device 30.

As will be appreciated, various types of sensing elements and converters may be used as the sensing element 32 and the converter 34 depending upon the type of the sensing device 30. For example, when the sensing device 30 is a temperature sensor, a thermistor and a corresponding coversion may be respectively used as the sensing element 32 and the converter 34. The thermistor may have different resistance values depending upon the temperature. The coversion may preferably be designed so as to convert the resistance values of the thermistor to representative voltages.

Also, when the sensing device 30 is a revolution speed sensor for a ventilation fan, a pulse generating circuit and a frequency-voltage (F-V) coversion may respectively be used as the sensing element 32 and the converter 34. The pulse generator circuit may preferably be designed so as to generate a pulse having a frequency corresponding to a revolution speed of the ventilation fan. The F-V coversion may preferably be designed so as to convert the pulse from the pulse generator to a representative voltage.

The connector plugs 38 of the sensing devices 30 respectively have a plurality of contacts or connector pins 1-8. Also, the connector plugs 38 may preferably have the same shape (e.g., a LAN connector plug shape) and have the same pin arrangement. The connector pins 1-3 are arranged and constructed to respectively be applied with a voltage of +12V, a reference voltage or ground (GND) and a voltage of −12V that are supplied from the measuring device 20. The connector pins 5 and 6 are arranged and constructed to output the analog sensing voltages generated by the converter 34. Further, the connector pins 4, 7 and 8 are arranged and constructed to output the sensing device identification signals generated by the identification signal generator 35. Further, the connector plugs 38 may preferably be shaped to engage the connector sockets CH1-CH32 so that the sensing devices 30 can be reliably connected to the measuring device 20. That is, the connector pins 1-8 of each of the connector plugs 38 may preferably be arranged and constructed to correspond to the connector slots 1-8 of each of the connector sockets CH1-CH32.

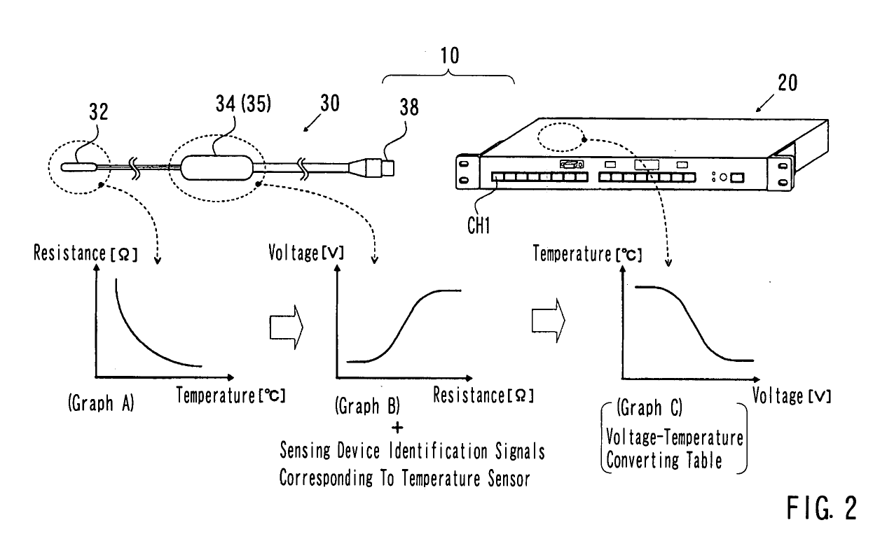

Operation of the environmental measuring apparatus 10 described according to this embodiment will now be outlined with reference to FIG. 2. A temperature sensor will be herein exemplified as the sensing devices 30. Therefore, the sensing element 32 and the detecting values respectively correspond to the thermistor and the temperatures within the server rack.

First, the sensing element 32 (i.e., the thermistor) of the sensing device 30 detects the temperatures within the server rack so as to have resistance values corresponding to the temperatures. As shown by Graph A in FIG. 2, the resistance values of the sensing element 32 can change depending upon the temperature. Subsequently, the converter 34 receives and converts the resistance values of the sensing element 32 and generates representative analog sensing voltages. As shown by Graph B in FIG. 2, the generated analog sensing voltages may change depending upon the resistance values. Thereafter, the converter 34 transmits the generated analog sensing voltages to the measuring device 20. At the same time, the identification signal generator 35 transmits the sensing device identification signals corresponding to the sensing device 30 (the temperature sensor) to the measuring device 20 so that the measuring device 20 can identify that the sensing device 30 is the temperature sensor. Further, the sensing device identification signals may include an analog identification voltage (i.e., one of some levels of analog voltages) and two digital identification signals (i.e. ON or OFF signal) which are respectively outputted from the connector pins 4, 7 and 8.

The measuring device 20 receives the analog sensing voltages and the three sensing device identification signals. The measuring device 20 identifies the sensing device 30 as the temperature sensor based on the received sensing device identification signals. Also, the measuring device 20 selects a predetermined voltage-temperature converting table (i.e., Graph C in FIG. 2) corresponding to the temperature sensor from a plurality of predetermined voltage-physical value converting tables previously stored in a memory device (not shown) of the measuring device 20 based on the received sensing device identification signals. Thereafter, the measuring device 20 converts the received analog sensing voltages to temperature values with reference to the appropriate voltage-temperature converting table.

Practically, the sensing device 30 (e.g., the temperature sensor) is previously assigned a special combination of the sensing device identification signals (which will be hereinafter referred to as “a sensing device identification data (ID)”). Similarly, the corresponding voltage-physical value converting table (e.g., the voltage-temperature converting table) is previously assigned the same sensing device ID. In this embodiment, the sensing device ID assigned for the temperature sensor and the corresponding voltage-temperature converting table is a combination of the analog identification voltage [0V (0±0.2V)], the digital identification signal [OFF] and the digital identification signal [ON]. This, combination is designated as a sensing device ID No. 2 (FIG. 4). Thus, the measuring device 20 can identify the sensing device 30 as the temperature sensor and select the corresponding voltage-temperature converting table based on the sensing device ID No. 2.

Next, a typical structure of the measuring device 20 of the environmental measuring apparatus 10 will be described in detail with reference to FIG. 3. As will be apparent from FIG. 3, only the connector sockets CH1 and CH32 are shown for simplification purposes. Further, in FIG. 3, the arrangement of the connector slots 1-8 of the connector sockets CH1 and CH32 is shown in series for explanatory purposes. The connector slots 1-8 actually have the same arrangement as the connector pins 1-8 of the connector plug 38 of the sensing device 30 shown in FIG. 1(B). (Correspondingly, the arrangement of the connector pins 1-8 of the connector plugs 38 of the sensing device 30 is also shown in series in FIG. 3.)

The measuring device 20 includes a power supply 26. The power supply 26 is electrically connected to the connector slots 1-3 of each of the connector sockets CH1-CH32 so as to respectively supply the voltage of +12V, the reference voltage or ground (GND) and the voltage of −12V to the connector slots 1-3. Therefore, the connector pins 1-3 of the sensing devices 30 can be respectively supplied with the voltage of +12V, the reference voltage or ground (GND) and the voltage of −12V via the connector slots 1-3 of the connector sockets CH1-CH32.

The measuring device 20 includes selection circuits S1-S3. The selection circuit S1 is connected to the connector slots 5 and 6 of the connector sockets CH1-CH32 via amplifiers A1-A32. Therefore, the analog sensing voltages generated by the converter 34 (FIG. 1(B)) of each sensing device 30 can be transmitted to the selection circuit SI via the corresponding connector pins 5 and 6 and connector slots 5 and 6.

The selection circuit S2 is connected to the connector slots 4 of the connector sockets CH1-CH32. Therefore, the analog identification voltage generated by the identification signal generator 35 (FIG. 1(B)) of each sensing device 30 can be transmitted to the selection circuit S2 via the corresponding connector pin 4 and connector slot 4. Also, the selection circuit S3 is connected to the connector slots 7 and 8 of the connector sockets CH1-CH32. Therefore, the digital identification signals (ON or OFF) generated by the identification signal generator 35 (FIG. 1(B)) of each sensing device 30 can be transmitted to the selection circuit S3 via the corresponding connector pins 7 and 8 and connector slots 7 and 8.

The measuring device 20 further includes a microprocessor or central processing unit (CPU) 22. The CPU 22 is connected to the selection circuits SI and S2 via a selection circuit S4 and an analog-digital (A/D) conversion circuit 25 so that the analog sensing voltages from the selection circuit S1 and the analog identification voltages from the selection circuits S2 can be selected and A/D converted and then supplied thereto. Also, the CPU 22 is directly connected to the selection circuit S3 so that the digital identification signals (ON or OFF) from the selection circuit S3 can be directly supplied thereto.

In addition, the CPU 22 communicates with the selection circuits S1 and S2 via a selection command transmission line CS12. The CPU 22 is constructed to transmit a selection command to the selection circuits S1 and S2 via the line CS12 so as to select and actuate their outputs corresponding to one of the connector sockets CH1-CH32. Also, the CPU 22 communicates with the selection circuits S3 via a selection command transmission line CS3. The CPU 22 is constructed to transmit a selection command to the selection circuits S3 via the line CS3 so as to select and actuate its output corresponding to one of the connector sockets CH1-CH32. Further, the CPU 22 communicates with the selection circuit S4 via a selection command transmission line CS4. The CPU 22 is constructed to transmit a selection command to the selection circuits S4 via the line CS4 so as to select and actuate its output corresponding to either one of the selection circuits S1 and S2.

The CPU 22 is connected to a random access memory (RAM) 23 and a read only memory (ROM) 24 that stores various programs and data (e.g., the voltage-physical value converting tables) so as to perform various processing (e.g., converting from the analog sensing voltages to the physical values) by utilizing the programs and data. The ROM 24 may preferably be an electrically reloadable ROM such as an electrically erasable and programmable ROM (EEPROM) and a Flash ROM. Such a ROM enables changing or reloading the stored programs and data as required. (Using such a ROM would be beneficial if it is expected to change the types of the sensing devices 30.)

The CPU 22 may include various interfaces and connectors in order to communicate with external equipment. In this embodiment, the CPU 22 has conversion circuits IF3 and IF4 (e.g., communication signal conversion circuits utilizing RS485), a conversion circuit IF34 (e.g., a conversion circuit for converting RS485 to RS232C), a conversion circuit IF2 (e.g., a communication signal conversion circuit utilizing RS232C) and a conversion circuit IF1 (e.g., a conversion circuit for converting RS232C to LAN). Further, the conversion circuits IF1, IF2, IF3, IF4 and IF34 are appropriately connected to the connector R1 (e.g., a LAN connector), the connector R2 (e.g., a connector for RS232C) and the connectors R3 and R4 (e.g., connectors for RS485) that are provided on the measuring device 20 so that the CPU 22 can communicate with the external equipment.

The CPU 22 further includes a light-emitting diode (LED) that is arranged and constructed to emit, quench or blink depending on the condition of the conversion circuit IF1. Also, the CPU 22 includes a shut down switch Ssw that is connected to the conversion circuit IF1. In addition, the CPU 22 includes an apparatus ID selector switch Isw, which will be described later.

Measuring processes of the environmental measuring apparatus 10 will now be described in detail with reference to FIGS. 2-4. The temperature sensor that is connected to the connector socket CH1 will be herein exemplified as the sensing devices 30. Therefore, the sensing element 32 and the detecting value respectively correspond to the thermistor and the temperatures within the server rack.

As previously described, the sensing element 32 (i.e., the thermistor) detects the temperatures within the server rack and has resistance values corresponding to the temperatures. Subsequently, the converter 34 receives and converts the resistance values of the sensing element 32 and generates the representative analog sensing voltages. At the same time, the identification signal generator 35 generates the sensing device identification signals corresponding to the temperature sensor. Further, as shown by the sensing device ID No. 2 in FIG. 4, the sensing device identification signals corresponding to the temperature sensor is the analog identification voltage [0V (0±0.2V)], the digital identification signal [OFF] and the digital identification signal [ON] which respectively correspond to the connector pins 4, 7 and 8 of the connector plug 38.

The analog sensing voltages and the sensing device identification signals thus generated are transmitted to the measuring device 20 via connector pins 4-8 and the corresponding connector slots 4-8. The analog sensing voltages and the sensing device identification signals transmitted to the measuring device 20 are introduced into the selection circuits S1-S3. At this time, the CPU 22 transmits the selection command to the selection circuits S1 and S2 via the selection command transmitting line CS12 in order to specify the connector socket CH1 so that the selection circuits S1 and S2 actuate their outputs corresponding to the connector socket CH1. Also, the CPU 22 transmits the selection command to the selection circuit S4 via the selection command transmitting line CS4 in order to specify the selection circuit S2 so that the selection circuit S4 actuates its output corresponding to the selection circuit S2. As a result, the sensing device identification signal (i.e., the analog identification voltage [0V]) corresponding to the connector slot 4 of the connector socket CH1 is transmitted to the A/D conversion circuit 25 so as to be converted to a corresponding digital signal. The digital signal thus produced is inputted to the CPU 22 from the A/D conversion circuit 25. Further, the CPU 22 transmits the selection command to the selection circuits S3 via the selection command transmitting line CS3 in order to specify the connector socket CH1 so that the selection circuit S3 actuates its outputs corresponding to the connector socket CH1. As a result, the sensing device identification signals (i.e., the digital identification signals [OFF] and [ON]) corresponding to the connector slots 7 and 8 of the connector socket CH1 are inputted to the CPU 22 from the selection circuit S3.

Thus, the CPU 22 receives the converted digital signal (which corresponds to the analog identification voltage [0V]), the digital identification signal [ON] and the digital identification signal [OFF], thereby identifying the sensing device 30 connected to the connector socket CH1 as the temperature sensor and selecting the voltage-temperature converting table based on the received three digital signals (which correspond to the sensing device ID No. 2).

Thereafter, the CPU 22 transmits the selection command to the selection circuit S4 via the selection command transmitting line CS4 in order to specify the selection circuit S1 so that the selection circuit S4 actuates its output corresponding to the selection circuit S1. At this time, the CPU 22 continuously transmits the same selection command to the selection circuits S1 and S2 via the selection command transmitting line CS12 in order to specify the connector socket CH1. As a result, the analog sensing voltages corresponding to the connector slots 5 and 6 of the connector socket CH1 are transmitted to the A/D conversion circuit 25 so as to be converted to a corresponding digital sensing signal. The digital sensing signal thus produced is inputted to the CPU 22 from the A/D conversion circuit 25. Naturally, the CPU 22 continuously transmits the same selection command signal to the selection circuits S3 via the selection command transmitting line CS3.

The CPU 22 converts the received digital sensing signal to a corresponding temperature value with reference to the selected voltage-temperature converting table (i.e., Graph C shown in FIG. 2). Thus, CPU 22 can determine that the sensing device 30 connected to the connector socket CH1 is the temperature sensor and that the detected physical value is the temperature.

Typically, such a series of processes with regard to each of the connector sockets CH1-CH32 can be performed every about thirty milli-second. Therefore, it is possible to identify the types of all of the sensing devices 30 and determine the corresponding physical values in about one second.

Further, the CPU 22 can be connected to the management unit (not shown) by utilizing the connector R1 so as to periodically transmit the detected physical values thereto. Also, the CPU 22 can be connected to an alarm device K (e.g., an alarm buzzer and an alarm lamp) so that the measuring device 20 can alert when an abnormality is detected, for example when an extraordinarily high temperature (e.g., a temperature exceeding 60 degrees Celsius) is detected.

Now, the details of the sensing device ID (i.e., the combinations of the sensing device identification signals) will now be described with reference to FIG. 4.

In this embodiment, the measuring device 20 has the thirty two connector sockets CH1-CH32. That is, the measuring device 20 is intended to connect to thirty two different types of sensing devices 30 so as to determine up to thirty two physical values. (In FIG. 4, only eight of the sensing devices 30 are listed as examples.) To this end, the identification signal generator 35 of each of the sensing devices 30 can be optionally set such that the connector pins 4, 7 and 8 may respectively output eight different analog identification voltages (i.e., 0V-8V), the digital identification signal [ON (i.e., High Level)] and the digital identification signal [OFF] (i.e., Low Level)]. Thus, it is possible to produce thirty two different sensing device ID, i.e., thirty two combinations of the analog identification voltages and the ON and OFF signals (8×2×2=32). As a result, the measuring device 20 can identify all of the thirty two different types of sensing devices 30.

The measuring device 20 is arranged and constructed to determine the analog identification voltages from the connector pins 4 in consideration of an error. For example, the measuring device 20 may determine the voltages in a range of 1±0.2V (i.e., 0.8V-1.2V) as 1V.

In order to set the identification signal generator 35 of each of the sensing devices 30 such that the connector pins 7 and 8 may respectively output the digital identification signals [ON (i.e., High Level)], the connector pins 7 and 8 are simply connected to the connector pins 1 that are supplied with the voltage of +12V from the power supply 26. Conversely, in order to set the identification signal generator 35 of each of the sensing devices 30 such that the connector pins 7 and 8 may respectively output the digital identification signals [OFF (i.e., Low Level)], the connector pins 7 and 8 are simply connected to the connector pins 2 that are supplied with the GND from the power supply 26. Also, in order to set the identification signal generator 35 of each of the sensing devices 30 such that the connector pins 4 may output the analog identification voltage, the connector pins 4 are connected to the pins 1 and 2 via two resistors (not shown).

Further, the sensing devices 30 can be modified such that the connector pins 4 output the ON and OFF digital identification signals instead of the analog identification voltages if it is expected to use a reduced number of sensing devices 30 (i.e., not more than eight). In such a case, it is possible to produce eight (2×2×2) different sensing device IDs. Also, in this case, the selection circuits S2 and S4 can be removed from the measuring device 20. Therefore, the measuring device 20 can be simplified.

Moreover, the sensing devices 30 can be modified such that the connector pins 7 and/or 8 output the analog identification voltages (e.g., eight different analog identification voltages) instead of the ON and OFF digital identification signals, if necessary. In such a case, it is possible to produce 128 (8×8×2) or 512 (8×8×8) different sensing device IDs. Therefore, it is possible to increase the number of the sensing devices 30 without adding additional connector pins. As will be recognized, the connector pins 7 and/or 8 can be easily changed to output the analog identification voltages without incorporating additional devices to the measuring device 20 because the measuring device 20 already includes the A/D conversion circuit 25. Naturally, if the sensing devices 30 are changed in design such that the connector pins 7 output the analog identification voltages, the selection circuit S2 is connected to the connector slots 4 and 7 of the connector sockets CH1-CH32. (Instead, the selection circuit S3 is connected to only the connector slots 8 of the connector sockets CH1-CH32.) Similarly, if the sensing devices 30 are changed in design such that the connector pins 7 and 8 output the analog identification voltages, the selection circuit S2 is connected to the connector slots 4, 7 and 8 of the connector sockets CH1-CH32. (In this case, the selection circuit S3 can be omitted from the measuring device 20.)

Next, an environmental measuring system having a plurality of present environmental measuring apparatus 10 (the measuring device 20) will be described with reference to FIG. 5. Further, the environmental measuring system having nine environmental measuring apparatus 10 will be herein exemplified.

The nine environmental measuring apparatus 10 are arranged in three lines A-C and three rows 1-3. Therefore, these nine environmental measuring apparatus 10 thus arranged will be herein designated with reference to the lines and the rows, if necessary. For example, the environmental measuring apparatus 10 disposed on the line A and the row 1 will be herein designated by a reference number A-1.

Each of these nine environmental measuring apparatus 10 thus arranged is previously assigned a special environmental measuring apparatus identification data (which will be hereinafter simply referred to as “an apparatus identification data (ID)”). For example, as shown in FIG. 5, the three environmental measuring apparatus A-1, A-2 and A-3 disposed on the line A are respectively assigned apparatus identification ID [:00], [01:00] and [02:00]. As will be appreciated, the apparatus identification ID of each environmental measuring device 10 can be set by operating the apparatus identification ID selector switch Isw that is included in the CPU 22 of the environmental measuring device 10.

The environmental measuring apparatus A-1 is connected to the management unit S via the conversion circuit IF1 by utilizing the LAN. The three environmental measuring apparatus A-1, A-2 and A-3 disposed on the line A are interconnected via the conversion circuits IF3. The conversion circuit IF4 of the environmental measuring apparatus A-1 is connected to the conversion circuit IF3 of the environmental measuring apparatus B-1 which is then connected to the conversion circuit IF3 of the environmental measuring apparatus C-1. Similarly, the conversion circuits IF4 of the environmental measuring apparatus A-2 and A-3 are respectively connected to the conversion circuits IF3 of the environmental measuring apparatus B-2 and B-3 which are then respectively connected to the conversion circuits IF3 of the environmental measuring apparatus C-2 and C-3. Further, with regard to the environmental measuring apparatus A-1, the conversion circuits IF1 and IF3 are connected to the conversion circuit IF34. Thus, the environmental measuring apparatus A-1 may successively correct all of the physical values detected by the environmental measuring apparatus A-1 to C-3 and periodically transmit the same to the managing unit S. As will be apparent, in most of the environmental measuring apparatus, except for the environmental measuring apparatus A-1, the conversions circuits IF1 and IF3 are not required.

According to the system thus constructed, only the environmental measuring apparatus A-1 is communicated with the management unit S by utilizing the LAN. Such an arrangement may reduce the communication traffic passing through the LAN, thereby reducing a load applied to the LAN and the management unit S. (As will be appreciated, the LAN is generally connected to many processing units (not shown).)

Further, Graphs A-C shown in FIG. 2 are used in the representative embodiment. However, it is possible to use different types of graphs. Also, the voltage-temperature converting table is not limited to a graph such as Graph C shown in FIG. 2. That is, the voltage-temperature converting table may be a voltage-temperature converting formula or other such means.

Moreover, the sensing device IDs shown in FIG. 4 are used in the representative embodiment. However, it is possible to use different types of sensing device IDs.

A representative example of the present invention has been described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the foregoing detailed description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present teachings.

1. An environmental measuring apparatus for measuring a plurality of environmental conditions within a server rack or a server room, comprising:
a plurality of sensing devices for detecting the plurality of environmental conditions, each of the sensing devices being arranged and constructed to generate at least one analog sensing voltage representative of a detecting value corresponding to the environmental condition and at least one sensing device identification signal corresponding to the sensing device; and
a measuring device electrically connected to the sensing devices and having a plurality of predetermined voltage-physical value converting tables previously stored therein, the measuring device being constructed to identify each of the sensing devices based on the at least one sensing device identification signal, thereby selecting a corresponding voltage-physical value converting table from among the stored voltage-physical value converting tables and converting the at least one analog sensing voltage to a physical value with reference to the selected voltage-physical value converting table.

2. The environmental measuring apparatus as defined in claim 1, wherein the at least one sensing device identification signal comprises at least one analog identification voltage and at least one digital identification signal.

3. The environmental measuring apparatus as defined in claim 2, wherein the measuring device is constructed to identify each of the sensing devices based on a special combination of the at least one analog identification voltage and the at least one digital identification signal.

4. The environmental measuring apparatus as defined in claim 2, wherein the each of the sensing devices has a connector that is connected to the measuring device, the connector having a plurality of connector pins which are respectively assigned the at least one analog identification voltage and the at least one digital identification signal.

5. The environmental measuring apparatus as defined in claim 1, wherein each of the sensing devices comprises a sensing portion that detects the environmental condition and generates the detecting value, and a converting portion that converts the detecting value and generates the at least one analog sensing voltage.

6. The environmental measuring apparatus as defined in claim 5, wherein the converting portion comprises an identification signal generator that generates the at least one sensing device identification signal.

7. An environmental measuring apparatus for measuring a plurality of environmental conditions within a server rack or a server room, comprising:
a plurality of sensing devices for detecting the plurality of environmental conditions, wherein each of the sensing devices is arranged and constructed to generate at least one analog sensing value corresponding to the environmental condition and at least one sensing device identification signal corresponding to an associated type of the sensing device, and
a measuring device including a plurality of connector sockets, a power supply, an analog-digital converter and a microprocessor, wherein each of the sensing devices is connected to any of the connector sockets and receives a supply of electrical power from the power supply, wherein the at least one analog sensing value associated with each of the sensing devices is converted into a digital format by the analog-digital converter, and wherein the microprocessor further converts the digital format into a form representing the associated environmental condition based upon conversion information associated with the at least one sensing device identification signal of the corresponding sensing device.

8. The environmental measuring apparatus as defined in claim 7, wherein the conversion information for some of the plurality of sensing devices is in the form of a graph.

9. The environmental measuring apparatus as defined in claim 7, wherein the conversion information for some of the plurality of sensing devices is in the form of a table.

10. The environmental measuring apparatus as defined in claim 7, wherein the conversion information for some of the plurality of sensing devices is in the form of a formula.

11. The environmental measuring apparatus as defined in claim 7, wherein each of the plurality of connector sockets is configured in a local area network (LAN) connector socket shape.

12. The environmental measuring apparatus as defined in claim 7, wherein the conversion information for each of the plurality of sensing devices is stored in an electrically reloadable ROM.

13. The environmental measuring apparatus as defined in claim 7, wherein each of the plurality of sensing devices comprises a sensing portion for evaluating the environmental condition and generating a detecting value, and a converting portion that converts the detecting value into the at least one analog sensing value.

14. An environmental measuring apparatus for measuring at least one environmental condition within a server rack or a server room, comprising:
at least one sensing device for detecting the at least one environmental condition, wherein each of the sensing devices is arranged and constructed to generate at least one analog sensing value corresponding to the environmental condition and at least one sensing device identification signal corresponding to an associated type of the sensing device; and
a measuring device including at least one connector socket, a power supply, an analog-digital converter, and a microprocessor, wherein the at least one sensing device is connected to the at least one connector socket and receives a supply of electrical power from the power supply, wherein the at least one analog sensing value associated with the at least one sensing device is converted into a digital format by the analog-digital converter, and wherein the microprocessor further converts the digital format into a form representing the associated environmental condition based upon conversion information associated with the at least one sensing device identification signal of the corresponding sensing device.
